(19) United States
(12) Patent Application Publication
(10) Pub. No.: US 2021/0224869 A1
(43) Pub. Date: Jul. 22, 2021

(54) METHODS AND SYSTEMS FOR FACILITATING DONATION TRANSACTIONS AND REAL TIME DONOR NOTIFICATIONS

(71) Applicant: MASTERCARD INTERNATIONAL INCORPORATED, Purchase, NY (US)

(72) Inventors: Krishnakant SHARMA, Vadodara, IN (US); Sekhar Palli, Vadodara (IN); Abhishek Gondalia, Vadodara (IN); Pinakin Kansara, Nadiad (IN); Pratik Gandhi, Vadodara (IN)

(73) Assignee: MASTERCARD INTERNATIONAL INCORPORATED, Purchase, NY (US)

(21) Appl. No.: 17/152,614

(22) Filed: Jan. 19, 2021

(30) Foreign Application Priority Data
Jan. 22, 2020 (IN) 202041002793

(51) Int. Cl. G06Q 30/02; G06Q 40/02; G06Q 20/02; G06Q 20/42; G06Q 40/00; G06Q 20/40; G06F 16/28; G06F 16/22; G06F 9/54

(52) U.S. Cl. CPC G06Q 30/0279; G06Q 40/02; G06Q 20/02; G06Q 20/42; G06F 9/547; G06Q 20/405; G06F 16/285; G06F 16/22; G06Q 40/12

(57) ABSTRACT

Embodiments provide methods, and systems for monitoring donation transactions between donors and charity organizations. The method performed by server system includes facilitating category-wise donations to at least one charity account of charity organization from donors. Each category-wise donation is allocated for spending for particular donation category of donation categories. The method includes receiving request from charity organization to spend for first donation category of donation categories from donations earmarked for second donation category, determining set of donors who have donated for second donation category based on donation transaction history of second donation category, and sending authorization request signal to user devices of the set of donors for taking approval for disbursement from second donation category for first donation category. Upon receiving successful authorization response from at least threshold number of donors of the set of donors, the method further includes facilitating spend for first donation category from second donation category.

### RELATED APPLICATIONS

This application claims priority to Indian Application Serial No. 202041002793, filed Jan. 22, 2020, which is incorporated herein by reference in its entirety.

### TECHNICAL FIELD

The present disclosure relates to systems and methods for facilitating donation transactions and, more particularly to, enabling donors to make donations to a charity organization via electronic donation transactions and getting real time updates on their donated moneys via an application.

### BACKGROUND

Donations are widely in practice throughout the world for providing aid to people. People often seek out ways to help less fortunate individuals and/or individuals in need of assistance, be it in response to a natural disaster or tragedy, or through a desire to simply help someone down on their luck. Typically, such help is in the form of donations to the individuals. Many of the very finest educational, health care, and religious institutions and activities have long been devoted to their cause because of donations received from donors.

However, there are numerous non-government organizations (NGOs), which are fake and do fraudulent transactions with donation money. Therefore, many people are reluctant to donate money to charities for a variety of reasons. Some people believe that their small donations will not actually make a difference. Others are suspicious as to whether their donations will go to those in need or instead be used to cover administrative fees and other inappropriate expenditures. Further, it can be difficult to determine appropriate avenues for providing the donations for a particular cause. While the people making the donations want to be generous, they also want to get real time updates of donation usage, and particularly their monetary donations should be directed to individuals truly in need and will likely be used in a manner related to such need.

Thus, there is a need for a technical solution to minimize fraudulent transactions performed by the charity organizations and to provide transparency to the donors regarding appropriated usage of their donated moneys.

### SUMMARY

Various embodiments of the present disclosure provide systems, methods, electronic devices and computer program products for facilitating donation transactions between charity organizations and donors.

In an embodiment, a computer-implemented method for monitoring donation transactions between a donor and a charity organization is disclosed. The method includes facilitating, by a server system, category-wise donations to at least one charity account of the charity organization from a plurality of donors. Each category-wise donation is allocated for spending for a particular donation category of a plurality of donation categories associated with the charity organization. The method includes receiving, by the server system, a request from the charity organization to spend for a first donation category of the plurality of donation categories from donations earmarked for a second donation category. The method includes determining, by the server system, a set of donors who have donated for the second donation category based on a donation transaction history of the second donation category associated with the charity organization and sending, by the server system, an authorization request signal to user devices of the set of donors for taking approval for disbursement from the second donation category for the first donation category. Upon receiving successful authorization response from at least a threshold number of donors of the set of donors, the method further includes facilitating, by the server system, spend for the first donation category from the second donation category.

In another embodiment, a server system for monitoring donation transactions between donors and charity organizations is provided. The server system includes a communication interface configured to receive a request from a charity organization to spend for a first donation category of a plurality of donation categories from donations earmarked for a second donation category, and send an authorization request signal to user devices of a set of donors for taking approval for disbursement from the second donation category for the first donation category. The server system further includes a memory including executable instructions and a processor communicably coupled to the communication interface. The processor is configured to execute the instructions to cause the server system at least to facilitate category-wise donations to at least one charity account of a charity organization from a plurality of donors. Each category-wise donation is allocated for spending for a particular donation category of the plurality of donation categories associated with the charity organization. The processor is further configured to execute the instructions to cause the server system to determine the set of donors who have donated for the second donation category based on a donation transaction history of the second donation category associated with the charity organization. Upon reception of successful authorization response from at least a threshold number of donors of the set of donors, the server system is further caused to facilitate spend for the first donation category from the second donation category.

In yet another embodiment, a yet another computer-implemented for monitoring donation transactions between donors and charity organizations is disclosed. The method includes receiving, by a server system, a registration request from a charity organization, and facilitating, by the server system, issuance of at least one charity account for the plurality of donation categories to the charity organization. The registration request includes charity profile data and a plurality of donation categories associated with the charity organization. Each category-wise donation is allocated for spending for a particular donation category of a plurality of donation categories associated with the charity organization. The method includes facilitating, by the server system, category-wise donations to at least one charity account of a charity organization from a plurality of donors. The method includes implementing, by the server system, an application programming interface (API) at the charity organization for spending donation money associated with the particular donation category of the plurality of donation categories and generating and storing, by the server system, a data structure for mapping spend transaction data of the particular donation category to information associated with a number of donation transactions of the particular donation category in a database. The method further includes determining, by the server system, a set of donors who have donated for the second donation category based on a donation transaction history of the second donation category associated with the charity organization, and sending, by the server system, an authorization request signal to user devices of the set of donors for taking approval for disbursement from the second donation category for the first donation category. Upon receiving successful authorization response from at least a threshold number of donors of the set of donors, the method includes facilitating, by the server system, spend for the first donation category from the second donation category.

### BRIEF DESCRIPTION OF THE FIGURES

For a more complete understanding of example embodiments of the present technology, reference is now made to the following descriptions taken in connection with the accompanying drawings in which:

FIG. 1 is an example representation of a system, related to at least some example embodiments of the present disclosure;

FIG. 2 is a sequence flow diagram for registering a charity organization, in accordance with an example embodiment;

FIG. 3 is a sequence flow diagram for facilitating category-wise donations from a donor, in accordance with an example embodiment;

FIGS. 4A, 4B, 4C, and 4D, collectively, represent an example representation of a donation process flow displayed on a mobile device of the donor with corresponding User Interfaces (UIs), in accordance with an example embodiment;

FIGS. 5A and 5B, collectively, represent an example representation of donation withdrawal process displayed on a user device of the charity organization with corresponding UIs, in accordance with an example embodiment;

FIG. 6 represents a sequence flow diagram of donation withdrawal, in accordance with an example embodiment;

FIG. 7 represents a sequence flow diagram of donation spend or usage performed by the charity organization, in accordance with an example embodiment;

FIG. 8 represents a data structure (i.e. a debit mapping table) for mapping spend transaction and donation transactions, in accordance with one embodiment of the present disclosure;

FIG. 9 represents a simplified schematic representation of an example of donation utilization, in accordance with an example embodiment;

FIG. 10 represents a flow graph of a method for monitoring donation transactions between the charity organization and the donor, in accordance with an example embodiment.

FIG. 11 is a simplified block diagram of a server system, in accordance with one embodiment of the present disclosure; and

FIG. 12 is a simplified block diagram of a user device associated with the donor capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “charity account” used throughout the description refer to a financial account that is used to fund the financial transaction (interchangeably referred to as “spend transaction”). Examples of the charity account include, but are not limited to a savings account, a credit account, a checking account and a virtual payment account. The charity account may be associated with an entity such as a commercial entity, a company, a corporation, a governmental entity, a non-profit organization and the like. In some scenarios, a charity account may be a virtual or temporary payment account that can be mapped or linked to a primary payment account, such as those accounts managed by payment wallet service providers.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by various payment interchange networks such as Mastercard®.

### Overview

Various example embodiments of the present disclosure provide methods, systems, user devices and computer program products for monitoring donation transactions processed by a donor to a charity organization and providing real-time update information of donation usage.

In various example embodiments, the present disclosure describes a server system that facilitates donation transactions to the charity organization. The server system is configured to implement an Application Program Interface (API) at the charity organization to enable the charity organization to register itself for receiving category-wise donations from a plurality of donors. The charity organization provides information such as charity profile data and a plurality of donation categories associated with the charity organization for registration. The charity profile data may include, but not limited to, a charity transactional history, a credence rating of the charity organization, and a unique identifier of the charity organization. The plurality of donation categories may include, but not limited to, donation spending restrictions related to a particular merchant category, a product category, and a particular cause (for example, food, health, education etc.).

The server system is configured to store the charity profile data and the plurality of donation categories associated with each charity organization in a database. The server system is configured to facilitate issuance of at least one charity account to the charity account. In one embodiment, the server system is configured to send a request to an issuer for issuing a charity account with a functionality of earmarking money to each of the plurality of donation categories. The server system is configured to facilitate category-wise donations to at least one charity account associated with the charity organization from the plurality of donors.

In one embodiment, the donor uses a donor application on his/her mobile device to select the charity organization for the category-wise donation based on ratings associated with the charity organization and the plurality of donation categories associated with the charity organization. The server system is configured to store donation transaction details in the database for further use. Each category-wise donation is allocated for spending for a particular donation category of a plurality of donation categories associated with the charity organization.

The charity organization is able to spend money for the particular donation category. For example, the charity organization can purchase items from a merchant associated with the particular donation category. After spending, the charity organization uploads a spend receipt to the server system. The server system determines a number of donors whose money has been utilized for the spend. The server system generates a data structure for mapping spend transaction made by the charity organization to a number of donation transactions associated with the particular donation category. The number of donation transactions are utilized according to their chronological order of donation event. The number of donation transactions is related to a number of donors. The server system is also configured to send a notification message to each of the number of donors to inform their donation utilization in the spending.

In one embodiment, when the charity organization finds an insufficient balance for spending from a first donation category (i.e., transportation), the charity organization sends a request to the server system for taking approval to spend for the first donation category from donations earmarked for a second donation category (i.e., food). The server system is configured to determine a set of donors, who have donated for the second donation category, based on a donation transaction history of the second donation category associated with the charity organization. Thereafter, the server system is configured to send an authorization request signal to user devices of the set of donors for taking approval for disbursement from the second donation category for the first donation category. Upon receiving successful authorization response from at least a threshold number of donors of the set of donors, the server system facilitates spend for the first donation category from the second donation category. In one embodiment, the threshold number is determined based on an urgency value of spending event set by the charity organization for the first donation category. If the urgency value for the first donation category is higher, the threshold number (of donors) is decreased from a predefined threshold value.

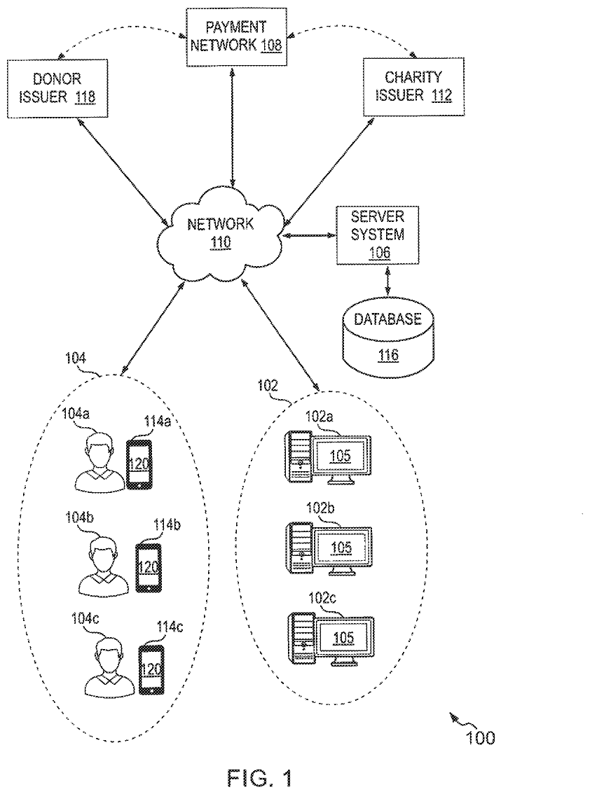

Various example embodiments of present disclosure are described hereinafter with reference to FIGS. 1 to 12.

FIG. 1 illustrates an exemplary representation of a system 100 related to at least some example embodiments of the present disclosure. Although the system 100 is presented in one arrangement, other embodiments may include the parts of the system 100 (or other parts) arranged otherwise depending on, for example, distribution of donation information to donors and/or charity organization, processing of donation transactions, etc. The system 100 generally includes a plurality of charity organizations 102a, 102b, 102c, a plurality of donors 104a, 104b, 104c, a payment network 108, a charity issuer 112, and a donor issuer 118 each coupled to, and in communication with (and/or with access to) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts or users illustrated in FIG. 1, or any combination thereof. For example, the network 110 may include multiple different networks, such as a private network made accessible by the payment network 108 to the issuers 112, 118 and, separately, a public network (e.g., the Internet etc.) through which the charity organizations 102a, 102b, 102c and the charity issuer 112 may communicate. The plurality of charity organizations 102a, 102b, 102c hereinafter are collectively represented as a “charity organization 102”. The plurality of donors 104a, 104b, 104c hereinafter are collectively represented as a “donor 104”.

The system 100 also includes a server system 106 configured to perform one or more of the operations described herein and a database 116. In general, the server system 106 is configured to facilitate donation transactions by donors (e.g., by the donor 104 etc.) to donees (e.g., to the charity organization 102 etc.). The server system 106 is a separate part of the system 100, and may operate apart from (but still in communication with, for example, via the network 110) the charity organization 102, the charity issuer 112, the payment network 108, and the donor issuer 118 to facilitate the donation transactions (and to access data to perform the various operations described herein). However, in other embodiments, the server system 106 may actually be incorporated, in whole or in part, into one or more parts of the system 100, for example, the donor issuer 118, the charity issuer 112, and/or the payment network 108 (as indicated by the dotted lines in FIG. 1). In addition, the server system 106 should be understood to be embodied in at least one computing device in communication with the network 110, which may be specifically configured, via executable instructions, to perform as described herein, and/or embodied in at least one non-transitory computer readable media.

The charity organization 102 is associated with a plurality of users (e.g., individuals, groups of individuals etc.), for example, individual donee (also referred to as a recipient herein). The charity organization 102 registers itself via a charity application 105 for soliciting donations from the plurality of donors. The charity organization 102 may provide charity profile data and information of a plurality of donation categories for registration to the server system 106. It should be appreciated that the charity organization 102 may relate to, or may encompass, donees sharing a common need for assistance (e.g., donees in need of assistance following a natural disaster, etc.), or the charity organization 102 may relate to, or may encompass, donees in general (e.g., any donees in need of assistance, regardless of reason, etc.). The charity organization 102 includes, without limitation, nonprofit organizations, religious organizations, aid organizations, health organizations, endowment organizations, environmental groups, non-governmental organizations (NGOs), and other philanthropic causes. In addition, the plurality of donors may include individual donors (such as donor 104), groups of donors, companies, etc.

After registration on the application, the server system 106 is configured to verify the received charity profile data from one or more government agencies, charity identity service providers or third parties. After successful verification, the server system 106 is configured to facilitate issuance of a charity account to the charity organization 102. The charity account may be broken up into one or more sub-accounts, which are associated with various donation restrictions, respectively, that limit use of donations for a particular donation category (although such restrictions are not required in all embodiments). Without limitation, such restrictions may relate to merchants, merchant categories, products, product categories, and/or spend amounts. For example, the charity account may include various restrictions that inhibits use of the charity account to purchase any dangerous drugs (or to effect transactions at merchants associated with the dangerous drugs). As another example, the charity account may include at least one donation restricted sub-account that only allows use of fund on groceries or education (or at merchants associated therewith). As still another example, the charity account may include a restricted sub-account that inhibits use of the charity account to purchase pharmaceutical or medicinal products (e.g., in general or based on an abuse history, etc.). The restrictions may be set by a member of the charity organization 102, and may be generic to the charity account for the charity organization 102. In addition, the restrictions may be stored in a data structure associated with the charity organization 102, in the database 116 associated with the server system 106, in a data structure associated with the charity issuer 112, and/or in a data structure associated with the payment network 108, based on desired access.

In another embodiment, the server system 106 is configured to facilitate issuance of one or more charity accounts to the charity organization 102. The one or more charity accounts are related to the plurality of donation categories. In one example, the server system 106 is configured to send a request to the charity issuer 112 for issuing the one or more charity accounts to the charity organization 102.

The donor 104 uses a donor application 120 on his/her mobile device 114 to select a charity organization based on ratings and the plurality of donation categories associated with the charity organization. The user device 114 and the mobile device 114 are used interchangeably throughout the present description. The user device 114 may be any electronic device such as, but not limited to, a personal computer (PC), a tablet device, a Personal Digital Assistant (PDA), a voice activated assistant, a Virtual Reality (VR) device, a smartphone and a laptop.

In one embodiment, the donor application 120 typically requires authentication/authorization of the donor 104 at the time of donation. For example, using a UI facilitated by the server system 106, the user is enabled to enter a username, a password, a PIN or a fingerprint to authenticate himself. Further, during enrollment, the donor application 120 requires the donor 104 to provide sensitive information such as personal information, contact information, financial information and the like. The donor application 120 may include at least one payment account therein that is issued by the donor issuer 118 which may correspond to a bank, a credit agency, or other type of financial institution. When the donor 104 opens the donor application 120, the mobile device 114 is configured to retrieve all previous donation records and recent donating events from the server system 106 and displays the previous donation records and the recent donating events in form of a dashboard to the donor 104. After clicking on an actionable button ‘Donate’ displayed in the dashboard, the donor application 120 is configured to display all donation categories and a data field for entering donation amount. Then, the donor 104 selects a donation category and enters a donation amount on the donor application 120. Based on the selected donation category, the donor application 120 presents one or more charity organizations in order of their ratings to the donor 104. The donor 104 selects any one or more charity organizations and completes the donation transaction. For example, the donor 104 may provide a donation for $1000.00 to a charity organization, but specify a donor preference limiting use of the donation to “Hunger” (as an added restriction to be applied when the charity organization uses the charity account, as described above).

In one embodiment, the charity organization 102 is configured to send a money withdrawal request for a donation category (i.e., donation Category “A”) to the server system 106. The money withdrawal request includes information of required amount to be spent by the charity organization 102 from the charity account earmarked for the donation category “A”. The server system 106 is configured to determine availability of the required amount in the charity account earmarked for the donation category “A.” If the balance in the charity account associated with donation category “A” is sufficient for the required amount, the server system 106 is configured to send a confirmation message to the charity organization 102 to utilize money of the donation category “A”. In response, the charity organization 102 performs a spend transaction for the donation category “A”. The charity organization 102 uploads a receipt of the spend transaction. The server system 106 is configured to extract spend transaction data, which may include, but not limited to, a transaction identifier, a spending amount, information of donation category “A”, merchant IDs of merchants involved in the spend transaction, merchant category codes (MCCs), and the charity profile data of the charity organization 102. The server system 106 is configured to determine a number of donation transactions which are utilized in the spend transaction. The number of donation transaction is associated with a number of donors. The number of donation transactions for the donation category “A” are utilized in a chronological order of donating events.

In one embodiment, the server system 106 is configured to generate a data structure for mapping the spend transaction data with an information associated with the number of donation transactions donated for the donation category “A.” Thereafter, the server system 106 is configured to store the data structure for traceability purposes and to send real time update to donors whose money is utilized in the spend transaction for the donation category “A”.

The server system 106 is configured to send a notification message to the number of donors whose money has been utilized for the spend transaction. The notification message may include, but not limited to, information associated with the spend transaction and donation utilization in the spend transaction. Based on the notification message, the number of donors will provide ratings to the charity organization 102.

In one embodiment, when the balance in the charity account associated with the donation category “A” is insufficient for the spending, the server system 106 is configured to check availability of the required amount in the charity account earmarked for another donation category (i.e., donation category “B”). If the requirement amount is available in the charity account earmarked for the donation category “B”, the server system 106 is configured to determine a set of donors, who have donated money for the donation category “B”, based on a donation transaction history associated with the donation category “B”.

Alternatively, in one embodiment, the charity application 105 is configured to display a total donation amount present in the charity account and a donation amount corresponding to each donation categories. When a donation amount balance in the charity account associated with the donation category “A” is insufficient for the spending, the charity organization 102 sends a request, via the charity application 105, to the server system 106 to utilize funds from the charity account earmarked for another donation category (i.e., donation category “B”) for the donation category “A”. After receiving the request, the server system 106 is configured to determine a set of donors, who have donated money for the donation category “B”, based on a donation transaction history associated with the donation category “B”.

The server system 106 is configured to send an authorization request signal to user devices of the set of donors for taking approval of utilizing funds associated with the donation category “B” for the donation category “A”. In response, when the server system 106 receives authorization responses (for example, “YES” response) from a threshold number of the set of donors, the server system 106 is configured to send a response to the charity organization 102 for allowing to use funds associated with the donation category “B” for the donation category “A” and facilitate utilization of funds associated with the donation category “B” for the donation category “A”. In one embodiment, the threshold number of donors may be a value indicating more than an eighty percent of the number of donors.

For instance, an amount (i.e., “$1200”) is required for spending from the charity account associated with the donation category “A”, and the earmarked money for the donation category “A” in the charity account does not have sufficient balance for the spending. The charity organization sends a request for spending from the donation category “B” for the donation category “A” to the server system 106. The server system 106 is configured to identify a set of donors X, Y, Z, and W associated with the donation category “B” who have donated $800, $300, $200, and $200, respectively. The server system 106 is configured to send an authorization request to each donor X, Y, Z, and W. In response, the server system 106 may receive the approval responses from a threshold number of all the donors such that approval responses of utilizing the required amount from the donation category “B” are received. In the example, the required amount (i.e. $1200) is less than a predetermined limiting value (i.e., “$2500”), the threshold number may be set as 50% of the all donors. In another example, if the required amount (i.e., “$3000”) is more than the limiting value (i.e., $2500), then the threshold number may be set as 75% of all donors. In one example, the threshold number may be set dynamically based on an urgency value associated with the spending for the donation category “A”. If the urgency value is higher than a predefined value, the threshold number may be set lower than a predefined threshold value. The predefined urgency and threshold values are set by the charity organization 102 or the server system 106.

In one embodiment, when the server system 106 receives authorization responses from a threshold number of donors of the set of donors, the server system 106 is configured to send an indication for facilitating utilization of funds from the donation category “B” for the donation category “A” to the charity issuer 112.

In one embodiment, the payment network 108 may be used by the payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between donors and charity organizations that are members of Mastercard International Incorporated®. (Mastercard is a registered trademark of Mastercard International Incorporated located in Purchase, N.Y.).

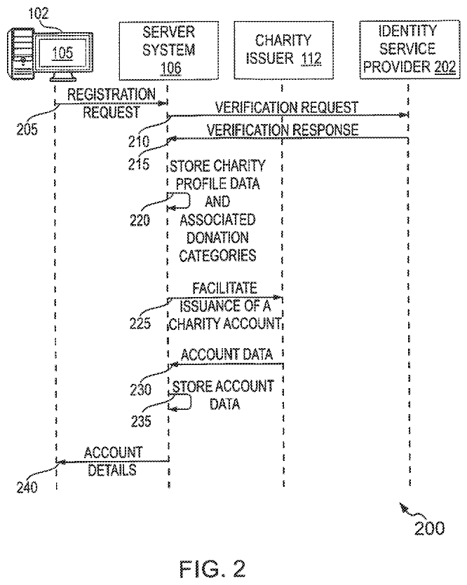

FIG. 2 represents a sequence flow diagram 200 for registering the charity organization 102, in accordance with an example embodiment. The sequence of operations of the sequence flow diagram 200 may not be necessarily executed in the same order as they are presented. Further, one or more operations may be grouped together and performed in form of a single step, or one operation may have several sub-steps that may be performed in parallel or in sequential manner.

At 205, the charity organization 102, through the charity application 105, sends a registration request to the server system 106 for registering the charity organization 102 to receive donation transactions for a plurality of donation categories and utilize the donations for spending for a particular donation category using network such as the network 110 of FIG. 1. In an embodiment, the server system 106 is configured to facilitate one or more charity registration Application Program Interfaces (APIs) to enable the charity organization 102 to register for receiving category-wise donations from a plurality of donors and spending the category-wise donations for the particular donation category. The registration request may include, but is not limited to, charity profile data and information of the plurality of donation categories. The charity profile data may include, but is not limited to, charity transactional archive, a credence rating of the charity organization, and a unique identifier of the charity organization. As previously described, the plurality of donation categories may include restrictions, for example, applying donation funds to a specific goal, applying donation funds to a specific category (e.g., hunger, education, health, clothing etc.) of spending, applying donation funds to non-restricted category for spending, disallowing use of the donation funds for a specific category of spending, assigning a time interval to set up a recurring donation, etc.

At 210, the server system 106 sends a verification request along with the registration request details to an identity service provider 202. Examples of the identity service provider 202 may include, but are not limited to, government agencies, independent certification agencies, or any other similar service providers.

At 215, the server system 106 receives a successful verification response from the identity service provider 202. At 220, the server system 106 stores the charity profile data and the information associated with the plurality of donation categories in the database 116.

At 225, the server system 106 facilitates issuance of a charity account to the charity organization 102. The server system 106 sends a request to the charity issuer 112 for issuing the charity account. The charity account has a functionality of earmarking money to each of the plurality of donation categories. In one embodiment, the charity account may include sub-accounts associated with the plurality of donation categories, respectively. For example, donations earmarked for a donation category “A” in the charity account can only be utilized for causes which are part of the donation category “A”. In another embodiment, the server system 106 facilitates issuance of different charity accounts for the plurality of donation categories and one charity account for non-category restriction. In yet another embodiment, the server system 106 facilitates issuance of donation category restricted prepaid cards for each of the plurality of donation categories and one non-restricted donation category prepaid card.

At 230, the server system 106 receives account data (i.e., charity account details) associated with the charity organization 102 from the charity issuer 112. At 235, the server system 106 stores the account data associated with the charity organization 102 for subsequent reference/use herein in the database 116.

The registered charity organization 102 is configured to access donated funds from donors such as, for example, the donor 104. At 240, the server system 106 shares the account data with the charity organization 102.

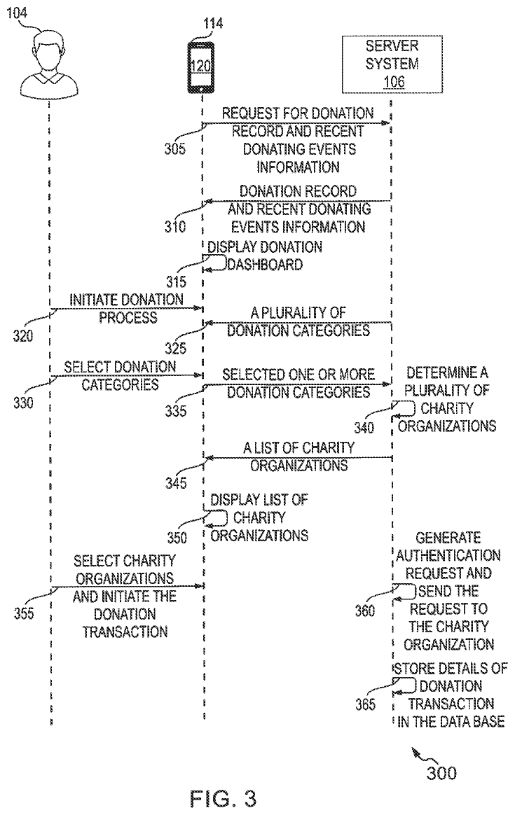

FIG. 3 is a sequence flow diagram 300 for facilitating category-wise donations from the donor 104, in accordance with an example embodiment. The sequence of operations of the sequence flow diagram 300 may not be necessarily executed in the same order as they are presented. Further, one or more operations may be grouped together and performed in form of a single step, or one operation may have several sub-steps that may be performed in parallel or in sequential manner.

When the donor 104 opens a donor application 120 installed on his/her mobile device 114, the mobile device 114 sends a request (see, 305) to the server system 106 for retrieving previous donation records associated with the donor 104 and information associated with any recent donating events. At 310, the mobile device 114 receives previous donation records associated with the donor 104 and the information associated with any recent donating events from the server system 106.

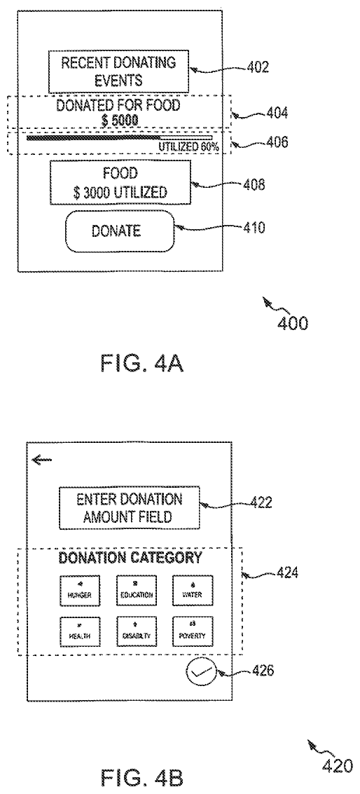

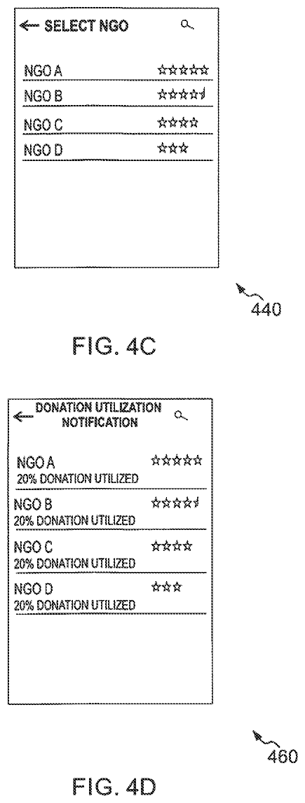

At 315, the donor application 120 displays the previous donation records and the recent donating events in form of a dashboard which is further described with reference to FIG. 4A.

At 320, the donor 104 initiates the donation process. In a non-limiting example, the donor 104 may click on an actionable button ‘Donate’ which directs the donor application 120 to another UI (representatively shown in FIG. 4B) that includes a plurality of donation categories information fields and an input data field for entering donation amount. For example, the plurality of donation categories includes, but is not limited to, “hunger”, “education”, “health”, “water”, “disability”, “poverty” etc., shown on the UI of FIG. 4B. At 325, the server system 106 sends information associated with the plurality of donation categories.

At 330, the donor 104 selects one or more donation categories from the plurality of donation categories displayed on the mobile device 114 via the donor application 120. At 335, the mobile device 114 sends information of the selected one or more donation categories to the server system 106.

At 340, based on the received information of the selected one or more donation categories, the server system 106 determines a plurality of charity organizations 102 who work in the fields of the selected one or more donation categories.

At 345, the server system 106 transmits a list of the plurality of charity organizations 102 along with their ratings to the mobile device 114. At 350, the mobile device 114 displays the list of plurality of charity organizations 102 in their order of ratings using the donor application 120.

At 355, once the donor 104 selects one or more charity organizations of the plurality of the charity organizations, the mobile device 114 initiates a donation transaction (via the donor application 120). It is noted that the operation 355 can be performed in a two-step. In connection herewith, the mobile device 114 sends a request for completing the donation transaction, via the server system 106, to the one or more charity organizations of the plurality of the charity organizations.

At 360, the server system 106 generates an authorization request for the donation transaction and transmits the authorization request to the selected charity organization 102 (or, potentially, via the charity issuer 112 and the payment network 108).

In one embodiment, if the donation transaction is approved, an authorization reply (indicating the approval of the donation transaction) is transmitted back from the charity organization 102 to the donor issuer 118, thereby permitting the donor 104 to process the donation transaction (e.g., append the donated funds to the charity account associated with the selected donation categories, etc.).

At 365, the server system 106 is configured to store details of donation transactions in the database 116.

In one embodiment, the server system 106 may associate the selected one or more donation categories provided by the donor 104 for use of the funds donated by the donor 104. As the donor 104 has provided the donation categories as part of the authorization request, such restrictions for the usage of the donated funds for the respective categories are stored with the server system 106. For instance, the restrictions may be stored in association with the charity account (in addition to the restrictions already associated with the charity account by the charity organization 102) with the server system 106. The additional restrictions can then be implemented, for example, by the charity issuer 112, etc., in connection with the donation transaction using the charity account and the donated funds. Additionally, the server system 106 may regularly monitor transactions to the charity account to ensure that the donated funds are utilized only for associated donation category.

FIGS. 4A to 4D, collectively, represent an example representation of a donation process flow displayed on the mobile device 114 of the donor 104 with corresponding User Interfaces (UIs), in accordance with an example embodiment.

As shown in FIG. 4A, a UI 400 displays a donation dashboard of the donor application 120. As explained with reference to FIG. 3, when the donor 104 opens the donor application 120 on the mobile device 114, the donor application 120 displays a plurality of information fields 402, 404, 406, and 408. The information field 402 represents the recent donating events, which upon selection may display the recent or ongoing charity or donation events (not shown). For example, the recent donating events may be a recently occurred natural disaster or tragedy. Further, the previous donation records donated by the donor 104 is shown in field 404, and category-wise donation utilizations is shown in field 406, as displayed in the donor application 120. For instance, as shown in illustrated embodiment of FIG. 4A, the donor 104 has previously donated a donation amount (see “$5000” in the field 404) for a specific donation category (“Food”). Additionally, in a representative example, the donation utilization (e.g., “60%” in the field 406) is displayed in form of a bar. The donor application 120 may also display an actionable icon 410 representatively shown as “Donate” in the illustrated representation of FIG. 4A. When the donor 104 selects the actionable icon 410, the mobile device 114 retrieves a plurality of donation categories from the server system 106, and thereafter, a UI 420 is displayed to the donor application 120.

As illustrated in the FIG. 4B, the UI 420 is shown displaying a form field 422 using which the donor 104 can enter a donation amount (exemplarily depicted as ‘$1000’). The form field 422 may allow the donor 104 to enter a numerical input to provide the donation amount. The UI 420 also includes a plurality of donation category fields (see 424). The donor 104 can select one or more donation category fields from the plurality of donation category fields. For instance, the donor 104 has selected two donation categories such as, “Hunger” and “Education”. Then, the donor 104 can click a button 426 to send the donation amount and the selected donation categories to the server system 106. The server system 106 transmits a list of charity organizations based on the selected donation categories to the mobile device 114. This is explained in detail by a UI 440 hereinafter.

In FIG. 4C, the UI 440 is shown displaying a list of charity organizations in an order of their ratings. The donor 104 selects one or more charity organizations from the list of charity organizations and clicks a button for completing the donation transaction (not shown in figure).

In FIG. 4D, a UI 460 is shown displaying donation utilizations associated with category-wise donations for each selected charity organization 102 to provide real time update of donation utilization thereby, the donor 104 can provide ratings and feedback to the charity organization 102 and can trace donation amount disbursed by the charity organization 102. In the UI 460, a percentage donation utilization corresponding to each charity organization 102 is displayed. For example, as shown in FIG. 4D “NGO A” has spent 20% of the donor's donated funds, and “NGO B” has spent 30% of the donor's donated funds.

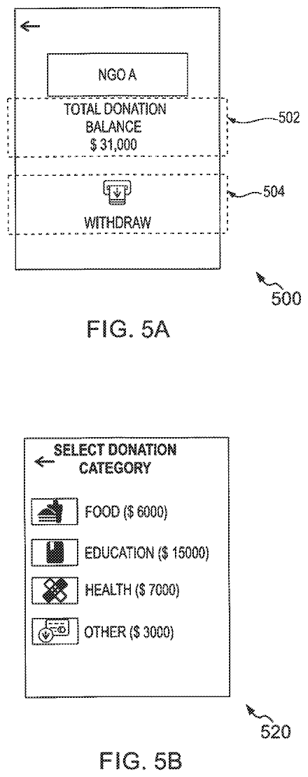

FIGS. 5A and 5B, collectively, represent an example representation of a user interface displayed in the charity application 105, in accordance with an example embodiment. In one embodiment, the server system 106 is configured to implement an Application Program Interface (API) at the charity organization 102 to enable the charity organization 102 to see donation amount balance for each donation category.

As shown in FIG. 5A (UI 500), during withdrawal donation process, the charity organization 102 (for example, “NGO A”) displays a total donation amount balance (see 502) for a plurality of donation categories. Thus, when the charity organization 102 selects an actionable icon 504, and thereafter, a UI 520 is displayed on the charity application 105. The charity application 105 displays category-wise donations for the plurality of donation categories and allows the charity organization 102 to select a particular donation category for spending. However, there may be scenarios when a donation amount balance for the particular donation category is not sufficient to spend for a particular event. In one example, the donation amount balance corresponding to a donation category (i.e., “food”) is “6000$” and the charity organization 102 desires to spend money (for example “$10000”) for the donation category (i.e., “food”). Hence, in this example, the charity organization 102 is not able to spend for the donation category (i.e., “food”) in desired manners. Even if the charity organization 102 may have a sufficient balance in other donation category, the charity organization 102 is not able to utilize donations associated with the other donation category (i.e., “education”) for the donation category (i.e., “food”) due to donation compliance rules set by the donor 104.

Therefore, to address the above scenario and to provide other benefits, embodiments of the present disclosure provide a method to broadcast real time notifications to a set of donors for taking approval of switching donation funds from donor's preferred donation category (which has a sufficient balance) to a donation category in which donation funds do not meet requirement of the charity organization 102. More specifically, various embodiments of present disclosure provide transmitting real time notifications to the set of donors, who have donated for a first donation category, for taking approval to utilize funds of the first donation category for a second donation category, thereby preventing the donation amount from being locked in a single donation category and utilizing money earmarked for one donation category in another donation category in emergency situations.

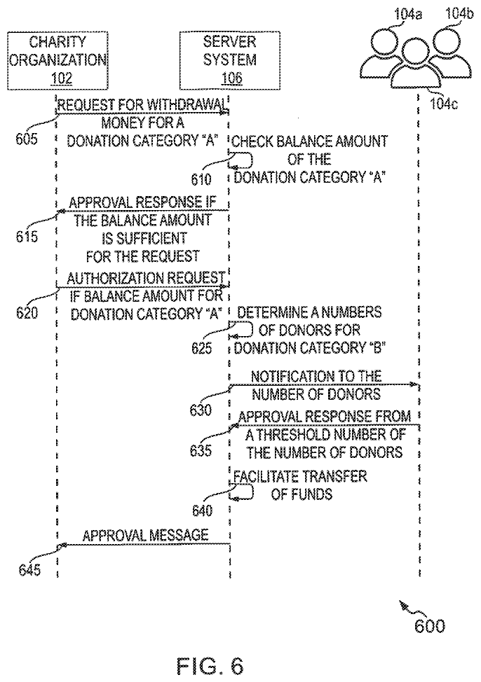

FIG. 6 is a sequence flow diagram 600 of donation withdrawal process, in accordance with an example embodiment. The sequence of operations of the sequence flow diagram 600 may not be necessarily executed in the same order as they are presented. Further, one or more operations may be grouped together and performed in form of a single step, or one operation may have several sub-steps that may be performed in parallel or in sequential manner.

At 605, the charity organization 102 sends a request for withdrawal money from the charity account associated with a first donation category (i.e., donation category “A”) to the server system 106, via the charity application 105. The request for withdrawal money includes information of an amount that is to be disbursed for the donation category “A” by the charity organization 102. For example, the donation category “A” is food and the charity organization 102 desires to purchase food groceries from a merchant.

At 610, the server system 106 checks balance amount of the charity account associated with the donation category “A”.

At 615, when a balance amount of the charity account associated with the donation category “A” is sufficient for the request, the server system 106 sends a response indicating approval of the withdrawal money request to the charity organization 102.

At 620, when the balance amount of the charity account associated with the donation category “A” is zero or the charity account associated with the donation category “A” does not have sufficient balance for spend, the charity organization 102 sends a request for taking approval of withdrawing funds from a second donation category (i.e., donation category “B”) for the donation category “A”. In one embodiment, the charity organization 102 sends the request along with an urgency value associated with the donation withdrawal from the donation category “A”. For example, the donation category “B” is education and the charity account associated with the donation category “education” has a sufficient balance to complete the desired purchase (for food) of the charity organization 102. In an alternate embodiment, the server system 106 is configured to identify the second donation category (i.e., donation category “B”).

At 625, the server system 106 determines a number of donors who have donated money for the donation category “B”. The number of donors is determined based on a transaction history information associated with the second donation category (i.e., donation category “B”).

At 630, the server system 106 sends an authorization request signal to the number of donors for taking consent of utilizing funds of the donation category “B” for the donation category “A”.

At 635, after receiving authorization responses from a threshold number of donors of the number of donors, the server system 106 facilitates utilization of funds of the donation category “B” for the donation category “A”.

In one embodiment, the threshold number of donors may be a value indicating more than an eighty percent of the number of donors. In another embodiment, the threshold number of donors is defined such that the requested money withdrawal request for the donation category “A” may be fulfilled.

In yet another embodiment, the threshold number may be adjusted based on an urgency value of spending event set by the charity organization 102 for the donation category “A”. For instance, the charity organization 102 requires an amount (“$10000”) for spending/purchasing from the donation category “food”, and the donation category “food” does not have a sufficient balance for the spending. Thereafter, the charity organization 102 sends a request for spending money for the donation category “food” from a donation category “education” to the server system 106. Then, the server system 106 sends an authorization request to a set of donors X, Y, Z, and W who have donated $7000, $3500, $4800, and $1000 for the donation category “education”, respectively.

In the example, the required amount (i.e. $10000) is less than a pre-determined amount (i.e., “$15000”), the threshold number may be set as 60% of the all donors. The pre-determined amount is set by the charity organization. In another example, if the required amount (i.e., “$20000”) is more than the pre-determined amount (i.e., $15000), then the threshold number may be set as 75% of all donors. In one example, the threshold number may be set dynamically based on an urgency value associated with the spending from the donation category “A”. If the urgency value is higher than a predefined value, the threshold number may be set as lower than a pre-determined threshold value.

At 640, the server system 106 facilitates spend from the donation category “B” for the donation category “A”. At 645, the server system 106 sends an approval message to the charity organization 102 indicating allowance of utilizing funds of the donation category “B” for the donation category “A”.

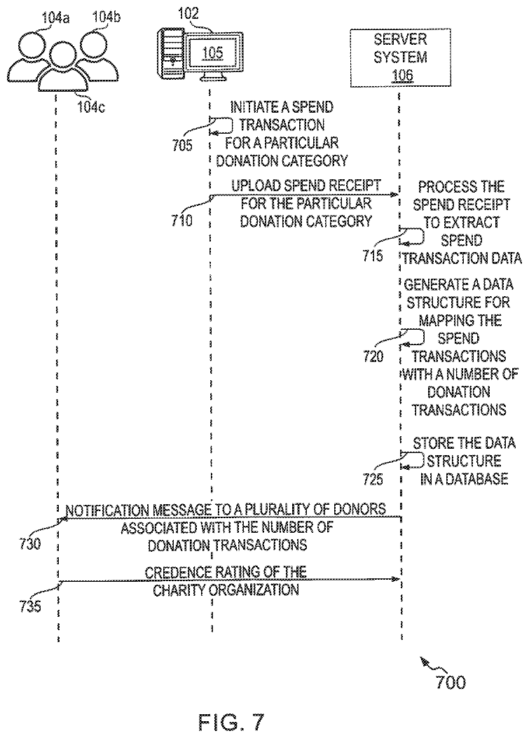

FIG. 7 is a sequence flow diagram 700 of donation spend or usage performed by the charity organization 102, in accordance with an example embodiment. The sequence of operations of the sequence flow diagram 700 may not be necessarily executed in the same order as they are presented. Further, one or more operations may be grouped together and performed in form of a single step, or one operation may have several sub-steps that may be performed in parallel or in sequential manner.

At 705, the charity organization 102 initiates a spend transaction (via the charity application 105) for a particular donation category (i.e. “health”). In one non-limiting example, the charity organization 102 initiates the spend transaction to a merchant for purchasing items related to medicines, drugs etc., via the server system 106, to merchant acquirers. In one embodiment, the server system 106 is configured to detect merchant category codes (MCC) associated with the merchant for confirming the spend transaction for the particular donation category.

In one embodiment, the charity organization 102 submits payment credentials associated with the charity account (e.g., PIN, Password etc.) to a merchant terminal associated with the merchant. In response, the merchant terminal submits an authorization request for the spend transaction to either the charity issuer 112 (as the issuer of the charity account) or the server system 106, via an acquirer (associated with the merchant) and through the payment network 108 (e.g., through Mastercard®, etc.).

In one embodiment, the server system 106 determines whether the charity account for the charity organization 102 is in good standing and whether there are sufficient funds and/or credit to cover the spend transaction. The server system 106 (or, potentially, the charity issuer 112) determines whether the spend transaction is in compliance with any restrictions associated with the charity account (e.g., as set by the charity organization 102, as subsequently requited by donors, etc.). If the charity issuer 112 approves the spend transaction, an authorization response (indicating the approval of the transaction) is transmitted back to the merchant, thereby permitting the merchant to complete the spend transaction.

After processing the spend transaction, the charity organization 102 receives a spend receipt for the particular donation category from the merchant. In one embodiment, the spend receipt for the particular donation category may include, but not limited to, information such as a transaction identifier, a spending amount, the particular donation category, and merchant information.

At 710, the charity organization 102 uploads the spend receipt for the particular donation category to the server system 106.

At 715, the server system 106 processes the spend receipt for the particular donation category for extracting transaction information associated with the spend receipt to generate a data structure.

At 720, the server system 106 generates the data structure for mapping spend transactions with a number of donation transactions.

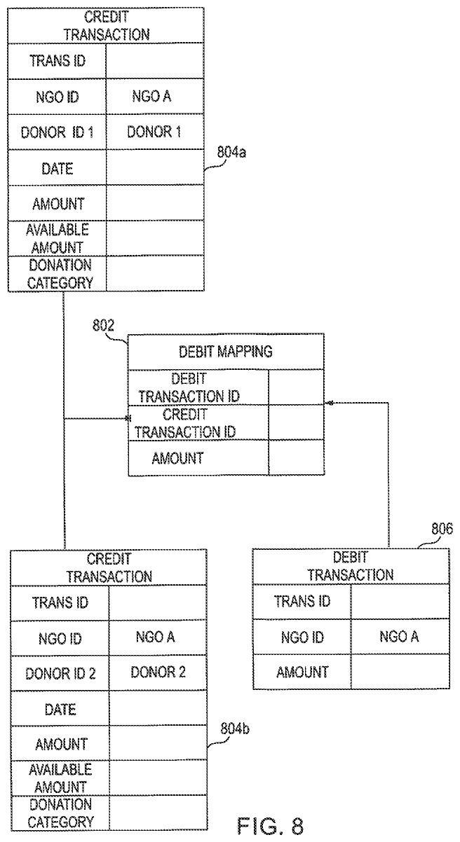

Referring now to FIG. 8, represents the data structure 802 (i.e. a debit mapping table) for mapping the spend transaction and donation transactions, in accordance with an example embodiment. The server system 106 is configured to generate the debit mapping table by mapping spend transaction data or debit transaction data (see, 806) with a number of donation transactions or credit transaction data (see, 804a, 804b), which are utilized in the disbursement performed by the charity organization 102.

The spend transaction data may include a plurality of information fields such as, for example, a transaction identifier, a spending amount, and the charity profile data (see, 806). The credit transaction data may include donation transaction information associated with a plurality of donors whose money are utilized in the spend for the particular donation category. The credit transaction data may include a plurality of donor data fields (see, 804a, 804b). The donor data fields may include data fields such as, but not limited to, a transaction identifier associated with the donation transaction, identity details associated with the donor, the particular donation category, and timestamp information. The timestamp information indicates a time of occurrence of a donation transaction. The donations associated with the plurality of donors are utilized in a chronological order of occurrence of donating event.

In one example, the debit transaction 806 is associated with “NGO A” which has spent “$7000” for a donation category “C”. The credit transaction 804a is associated with a donor (i.e., donor 1), who has donated “$5000” for the donation category “C” and the credit transaction 804b is associated with a donor (i.e., donor 2) who has donated “$2000” for the donation category “C”. The debit mapping table 802 indicates that the debit transaction or the spend transaction for the donation category “C” has consumed two credit transactions or donation transactions 804a and 804b.

Referring back to FIG. 7, at 725, the server system 106 stores the debit mapping table 802 in the database 116 for further reference. The debit mapping table 802 is utilized for traceability of donation transactions and for sending real-time donation utilization notification to the donors.

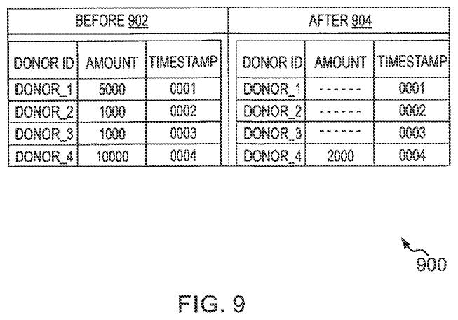

In one non-limiting example, referring now to FIG. 9, donor 1, donor 2, donor 3, and donor 4 have donated “$5000” at timestamp “0001”, “$1000” at timestamp “0002”, “$1000” at timestamp “0003”, and “$10000” at timestamp “0004”, respectively, to the charity organization 102 for a donation category “health” (see, 902). The charity organization 102 spends “$15000” from the charity account associated with the donation category “health”. After spending, remaining donated funds corresponding to the donor 1, donor 2, and donor 3 are zero, and donated funds corresponding to the donor 4 has a remaining balance (i.e., “$2000”) (see 904). Thus, the donation utilization is occurred in an order of donor's timestamp information.

At 730, the server system 106 sends a notification message to each of the plurality of donors. The notification message may include information associated with the spend transaction and donation utilization in the spend transaction. The donation utilization associated with each of the plurality of donors is determined based on a first-in-first-out (FIFO) method using the stored debit mapping table 802.

At 735, based on the notification message, the plurality of donors provides a credence rating to the charity organization 102 and the credence rating associated with the charity organization 102 is stored in the database 116 for subsequent use. It is noted that the operation 735 can be performed in a two-step.

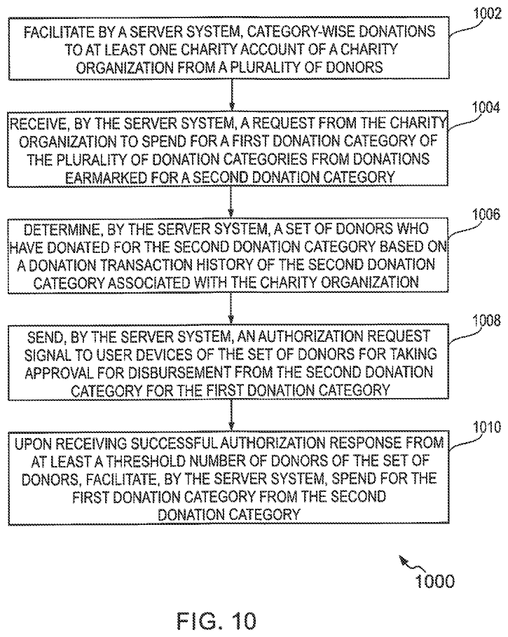

Referring now to FIG. 10, illustrates a flow diagram of a method 1000 for monitoring donation transactions between donors and charity organizations, in accordance with an example embodiment. The method 1000 depicted in the flow diagram may be executed by, for example, the at least one server system such as an issuer server. Operations of the flow diagram, and combinations of operation in the flow diagram, may be implemented by, for example, hardware, firmware, a processor, circuitry and/or a different device associated with the execution of software that includes one or more computer program instructions. The method 1000 starts at operation 1002.

At 1002, the method 1000 includes facilitating, by the server system 106, category-wise donations to at least one charity account of a charity organization 102 from a plurality of donors 104. The method 1000 further includes implementing, by the server system 106, an application programming interface (API) at the user device 114 of the donor 104 to select the charity organization 102 for transferring the category-wise donations. Further, each category-wise donation is allocated for spending for a particular donation category of a plurality of donation categories associated with the charity organization 102. Thereafter, the method 1000 includes generating and storing, by the server system 106, a data structure for mapping spend transaction data of the particular donation category to information associated with a number of donation transactions of the particular donation category in the database 116.

At 1004, the method 1000 includes receiving, by the server system 106, a request from the charity organization 102 to spend for a first donation category (i.e. donation category “A”) of the plurality of donation categories from donations earmarked for a second donation category (i.e. donation category “B”). The request includes an urgency value associated with the spending from the first donation category (i.e. donation category “A”).

At 1006, the method 1000 includes determining, by the server system 106, a set of donors 104 who have donated for the second donation category (i.e. donation category “B”) based on a donation transaction history of the second donation category (i.e. donation category “B”) associated with the charity organization 102.

At 1008, the method 1000 includes sending, by the server system 106, an authorization request signal to user devices of the set of donors for taking approval for disbursement from the second donation category (i.e. donation category “B”) for the first donation category (i.e. donation category “A”).

At 1010, the method 1000 includes facilitating, by the server system 106, spend for the first donation category (i.e. donation category “A”) from the second donation category (i.e. donation category “B”) upon receiving successful authorization response from at least a threshold number of donors of the set of donors. The threshold number is determined based on the urgency value of the spending from the first donation category (i.e. donation category “A”).

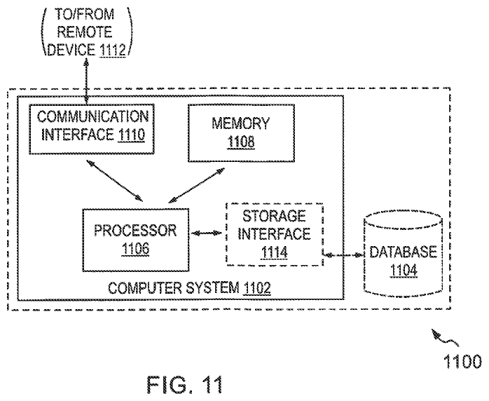

FIG. 11 is a simplified block diagram of a server system 1100, in accordance with one embodiment of the present disclosure. In one embodiment, the server system 1100 is an example of a server system that is a part of the payment network 108. Examples of the server system 1100 includes, but are not limited to, the charity issuer 112, the donor issuer 118 and a payment server. The server system 1100 is an example of the server system 106 shown and explained with reference to FIG. 1. The server system 1100 includes a computer system 1102 and a database 1104. The computer system 1102 includes at least one processor 1106 for executing instructions. Instructions may be stored in, for example, but not limited to, a memory 1108. The processor 1106 may include one or more processing units (e.g., in a multi-core configuration).

The processor 1106 is operatively coupled to a communication interface 1110 such that computer system 1102 is capable of communicating with a remote device 1112 such as the user mobile phone or communicating with any entity within the payment network 108. For example, the communication interface 1110 may receive donation transaction request from the donor 104.

The processor 1106 may also be operatively coupled to the database 1104. The database 1104 is any computer-operated hardware suitable for storing and/or retrieving data, such as, but not limited to, the charity profile data and the plurality of donation categories associated with the charity organization 102, a debit mapping table for mapping spend transactions (i.e. debit transactions) performed by the charity organization 102 with a number of donation transactions (referring to FIG. 8). The database 1104 may also store information related to account data associated with the charity organization 102. Each account data includes at least one of charity organization (for example, NGO identifier), a charity account number, and other account identifier. The database 1104 may also store a listing of a plurality of donation categories and the restrictions may be stored in data structure. The database 1104 may include multiple storage units such as hard disks and/or solid-state disks in a redundant array of inexpensive disks (RAID) configuration. The database 1104 may include a storage area network (SAN) and/or a network attached storage (NAS) system.

In some embodiments, the database 1104 is integrated within computer system 1102. For example, computer system 1102 may include one or more hard disk drives as the database 1104. In other embodiments, the database 1104 is external to the computer system 1102 and may be accessed by the computer system 1102 using a storage interface 1114. The storage interface 1114 is any component capable of providing the processor 1106 with access to the database 1104. The storage interface 1114 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1106 with access to the database 1104.

The processor 1106 is configured to facilitate category-wise donations to at least one charity account of the charity organization 102 from a plurality of donors 104a, 104b, 104c. The category-wise donations are allocated for spending for a particular donation category of a plurality of donation categories associated with the charity organization 102. The processor 1106 is further configured to generate a data structure for mapping spend transaction data of the particular donation category to information associated with a number of donation transactions of the particular donation category and store the data structure at the database 1104. In one embodiment, if an available balance in the charity account associated with the a first donation category (e.g., donation category “A”) is not sufficient for purchasing/spending, the communication interface 1110 is configured to receive a request from the charity organization 102 to spend for the donation category “A” from donations earmarked for a second donation category (e.g., donation category “B”). In response, the processor 1106 is configured to determine a set of donors who have donated for the donation category “B” based on a donation transaction history of the donation category “B” associated with the charity organization 102. The communication interface 1110 is configured to send an authorization request signal to user devices of the set of donors for taking approval for disbursement from the donation category “B” for the donation category “A”. In responsive to receive successful authorization response from at least a threshold number of donors of the set of donors, the processor 1106 is configured to facilitate spend for the donation category “A” from the donation category “B”.

In one embodiment, the processor 1106 is configured to facilitate spend transaction (for the donation category “A”) from the charity account associated with the donation category “B” to an acquirer account of a merchant based on the reception of successful authorization response. The processor 1106 is configured to notify the user device 114 (of the donor 104) and the charity organization 102 via the communication interface 1110.

The components of the server system 1100 provided herein may not be exhaustive, and that the server system 1100 may include more or fewer components than that of depicted in FIG. 11. Further, two or more components may be embodied in one single component, and/or one component may be configured using multiple sub-components to achieve the desired functionalities. Some components of the server system 1100 may be configured using hardware elements, software elements, firmware elements and/or a combination thereof.

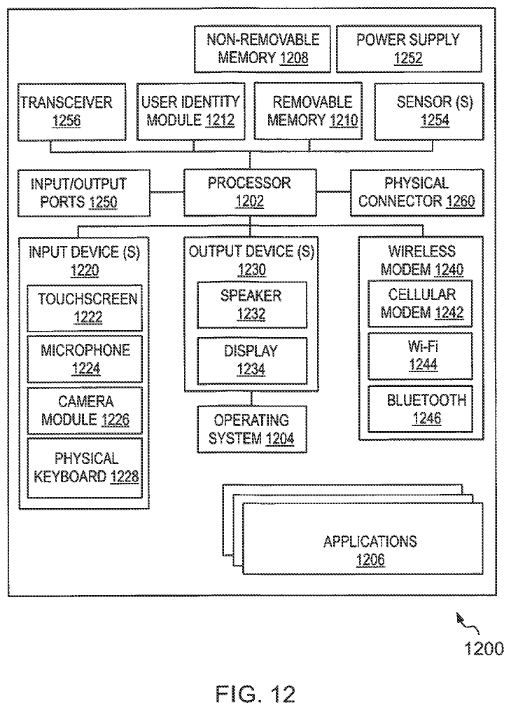

FIG. 12 shows simplified block diagram of a user device 1200 for example a mobile phone or a desktop computer capable of implementing the various embodiments of the present disclosure. For example, the user device 1200 may correspond to the user device 114 of FIG. 1. The user device 1200 is depicted to include one or more applications 1206 such as a donor application 1206 which is an example of the donor application 120 of FIG. 1. The donor application 1206 can be an instance of an application downloaded from the server system 106 or a third-party server. The donor application 1206 is capable of communicating with the server system 106 for facilitating category-wise donations to the charity organization 102.

It should be understood that the user device 1200 as illustrated and hereinafter described is merely illustrative of one type of device and should not be taken to limit the scope of the embodiments. As such, it should be appreciated that at least some of the components described below in connection with that the user device 1200 may be optional and thus in an example embodiment may include more, less or different components than those described in connection with the example embodiment of the FIG. 12. As such, among other examples, the user device 1200 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1200 includes a controller or a processor 1202 (e.g., a signal processor, microprocessor, ASIC, or other control and processing logic circuitry) for performing such tasks as signal coding, data processing, image processing, input/output processing, power control, and/or other functions. An operating system 1204 controls the allocation and usage of the components of the user device 1200 and support for one or more payment transaction applications programs (see, the applications 1206) such as the donor application, that implements one or more of the innovative features described herein. In addition, to the donor application, the applications 1206 may include common mobile computing applications (e.g., telephony applications, email applications, calendars, contact managers, web browsers, messaging applications) or any other computing application.

The illustrated user device 1200 includes one or more memory components, for example, a non-removable memory 1208 and/or removable memory 1210. The non-removable memory 1208 and/or the removable memory 1210 may be collectively known as a database in an embodiment. The non-removable memory 1208 can include RAM, ROM, flash memory, a hard disk, or other well-known memory storage technologies. The removable memory 1210 can include flash memory, smart cards, or a Subscriber Identity Module (SIM). The one or more memory components can be used for storing data and/or code for running the operating system 1204 and the applications 1206. The user device 1200 may further include a user identity module (UIM) 1212. The UIM 1212 may be a memory device having a processor built in. The UIM 1212 may include, for example, a subscriber identity module (SIM), a universal integrated circuit card (UICC), a universal subscriber identity module (USIM), a removable user identity module (R-UIM), or any other smart card. The UIM 1212 typically stores information elements related to a mobile subscriber. The UIM 1212 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1200 can support one or more input devices 1220 and one or more output devices 1230. Examples of the input devices 1220 may include, but are not limited to, a touch screen/a display screen 1222 (e.g., capable of capturing finger tap inputs, finger gesture inputs, multi-finger tap inputs, multi-finger gesture inputs, or keystroke inputs from a virtual keyboard or keypad), a microphone 1224 (e.g., capable of capturing voice input), a camera module 1226 (e.g., capable of capturing still picture images and/or video images) and a physical keyboard 1228. Examples of the output devices 1230 may include, but are not limited to a speaker 1232 and a display 1234. Other possible output devices can include piezoelectric or other haptic output devices. Some devices can serve more than one input/output function. For example, the touch screen 1222 and the display 1234 can be combined into a single input/output device.

A wireless modem 1240 can be coupled to one or more antennas (not shown in the FIG. 12) and can support two-way communications between the processor 1202 and external devices, as is well understood in the art. The wireless modem 1240 is shown generically and can include, for example, a cellular modem 1242 for communicating at long range with the mobile communication network, a Wi-Fi compatible modem 1244 for communicating at short range with an external Bluetooth-equipped device or a local wireless data network or router, and/or a Bluetooth-compatible modem 1246. The wireless modem 1240 is typically configured for communication with one or more cellular networks, such as a GSM network for data and voice communications within a single cellular network, between cellular networks, or between the user device 1200 and a public switched telephone network (PSTN).

The user device 1200 can further include one or more input/output ports 1250, a power supply 1252, one or more sensors 1254 for example, an accelerometer, a gyroscope, a compass, or an infrared proximity sensor for detecting the orientation or motion of the user device 1200 and biometric sensors for scanning biometric identity of an authorized user, a transceiver 1256 (for wirelessly transmitting analog or digital signals) and/or a physical connector 1260, which can be a USB port, IEEE 1294 (FireWire) port, and/or RS-232 port. The illustrated components are not required or all-inclusive, as any of the components shown can be deleted and other components can be added.

The disclosed method with reference to FIG. 10, or one or more operations of the method 1000 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1100 and its various components such as the computer system 1102 and the database 1104 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method for monitoring donation transactions between donors and charity organizations, the computer-implemented method comprising:
facilitating, by a server system, category-wise donations to at least one charity account of a charity organization from a plurality of donors, wherein each category-wise donation is allocated for spending for a particular donation category of a plurality of donation categories associated with the charity organization;
receiving, by the server system, a request from the charity organization to spend for a first donation category of the plurality of donation categories from donations earmarked for a second donation category;
determining, by the server system, a set of donors who have donated for the second donation category based on a donation transaction history of the second donation category associated with the charity organization;
sending, by the server system, an authorization request signal to user devices of the set of donors for taking approval for disbursement from the second donation category for the first donation category; and
upon receiving successful authorization response from at least a threshold number of donors of the set of donors, facilitating, by the server system, spend for the first donation category from the second donation category.

2. The computer-implemented method of claim 1, further comprising:
generating and storing, by the server system, a data structure for mapping spend transaction data of the particular donation category to information associated with a number of donation transactions of the particular donation category in a database.

3. The computer-implemented method of claim 1, further comprising:
receiving, by the server system, a registration request from the charity organization, the registration request comprising charity profile data and the plurality of donation categories associated with the charity organization;
facilitating, by the server system, issuance of the at least one charity account to the charity organization; and
implementing, by the server system, an application programming interface (API) at a user device of a donor to select the charity organization for transferring the category-wise donations, wherein the selection is based at least on the plurality of donation categories associated with the charity organization.

4. The computer-implemented method of claim 2, further comprising:
implementing, by the server system, an application programming interface (API) at the charity organization for spending donation money associated with the particular donation category of the plurality of donation categories;
receiving, by the server system, a receipt of spend transaction made by the charity organization for the particular donation category; and
upon receiving the receipt of spend transaction, determining, by the server system, a number of donors, whose donations are utilized in the spend transaction for the particular donation category, wherein the number of donors is associated to the number of donation transactions, and wherein the number of donation transactions are utilized in a chronological order of occurrence of donating event.

5. The computer-implemented method of claim 1, wherein the threshold number of donors is based at least on an urgency value associated with a spending event for the first donation category.

6. The computer-implemented method of claim 2, wherein the information associated with the number of donation transactions comprise at least transaction identifiers, donation amounts, timestamp information associated with each donation transaction, donor profile information, and information of the selected charity organization, and wherein the spend transaction data comprises at least a transaction identifier, a spending amount, the particular donation category, merchant information, and charity profile information of the charity organization.

7. The computer-implemented method of claim 3, wherein the charity profile data comprises at least a charity transactional archive, a credence rating of the charity organization, and a unique identifier of the charity organization, and wherein the plurality of donation categories is associated with charity donation restrictions, which are imposed by charity members.

8. The computer-implemented method of claim 7, wherein the charity donation restrictions comprise spending restrictions related to one or more of merchants, a merchant category, a product, a product category, and an amount of spend.

9. The computer-implemented method of claim 4, further comprising:
determining, by the server system, a donation utilization corresponding to each of the number of donors, wherein the determination of the donation utilization is based on a First-In-First-Out (FIFO) method; and
providing, by the server system, a notification message to each of the number of donors for rating the charity organization, the notification message comprising at least information of the donation utilization corresponding to each of the number of donors.

10. A server system for monitoring donation transactions between donors and charity organizations, the server system comprising:
a communication interface configured to
receive a request from a charity organization to spend for a first donation category of a plurality of donation categories from donations earmarked for a second donation category, and
send an authorization request signal to user devices of a set of donors for taking approval for disbursement from the second donation category for the first donation category;
a memory comprising executable instructions; and
a processor communicably coupled to the communication interface, the processor configured to execute the executable instructions to cause the server system to at least
facilitate category-wise donations to at least one charity account of the charity organization from a plurality of donors, wherein each category-wise donation is allocated for spending for a particular donation category of the plurality of donation categories associated with the charity organization,
determine the set of donors who have donated for the second donation category based on a donation transaction history of the second donation category associated with the charity organization, and
upon reception of successful authorization response from at least a threshold number of donors of the set of donors, facilitate spend for the first donation category from the second donation category.

11. The server system of claim 10, wherein the server system is further caused to:
generate and store a data structure for mapping spend transaction data of the particular donation category to information associated with a number of donation transactions of the particular donation category in a database.

12. The server system of claim 10, wherein the server system is further caused to:
receive a registration request from the charity organization, the registration request comprising charity profile data and the plurality of donation categories associated with the charity organization;
facilitate issuance of the at least one charity account to the charity organization; and
implement an application programming interface (API) at a user device of a donor to select the charity organization for transferring the category-wise donations, wherein the selection is based at least on the plurality of donation categories associated with the charity organization.

13. The server system of claim 11, wherein the server system is further caused to:
implement an application programming interface (API) at the charity organization for spending donation money associated with the particular donation category of the plurality of donation categories;
receive a receipt of a spend transaction made by the charity organization for the particular donation category; and
upon reception of the receipt of the spend transaction, determine a number of donors, whose donations are utilized in the spend transaction for the particular donation category, wherein the number of donors is associated to the number of donation transactions, and wherein the number of donation transactions are utilized in a chronological order of occurrence of donating event.

14. The server system of claim 10, wherein the threshold number of donors is based at least on an urgency value associated with a spending event for the first donation category.

15. The server system of claim 11, wherein the information associated with the number of donation transactions comprise at least transaction identifiers, donation amounts, timestamp information associated with each donation transaction, donor profile information, and information of the selected charity organization, and wherein the spend transaction data comprises at least a transaction identifier, a spending amount, and merchant information.

16. The server system of claim 12, wherein the charity profile data comprises at least a charity transactional archive, a credence rating of the charity organization, and a unique identifier of the charity organization, and wherein the plurality of donation categories is associated with charity donation restrictions, which are imposed by charity members.

17. The server system of claim 16, wherein the charity donation restrictions comprise spending restrictions related to one or more of merchants, a merchant category, a product, a product category, and an amount of spend.

18. The server system of claim 13, wherein the server system is further caused to:
determine a donation utilization corresponding to each of the number of donors, wherein the determination of the donation utilization is based on a First-In-First-Out (FIFO) method; and
provide a notification message to each of the number of donors for rating the charity organization, the notification message comprising at least information of the donation utilization associated with each of the number of donors.

19. A computer-implemented method for monitoring donation transactions between donors and charity organizations, the method comprising:
receiving, by a server system, a registration request from a charity organization, the registration request comprising a charity profile information and a plurality of donation categories associated with the charity organization;
facilitating, by the server system, issuance of at least one charity account for the plurality of donation categories to the charity organization;
facilitating, by the server system, category-wise donations to the at least one charity account of the charity organization from a plurality of donors, wherein each category-wise donation is allocated for spending for a particular donation category of the plurality of donation categories associated with the charity organization;
implementing, by the server system, an application programming interface (API) at the charity organization for spending donation money associated with the particular donation category of the plurality of donation categories;
generating and storing, by the server system, a data structure for mapping spend transaction data of the particular donation category to information associated with a number of donation transactions of the particular donation category in a database;
receiving, by the server system, a request from the charity organization to spend for a first donation category of the plurality of donation categories from donations earmarked for a second donation category;
determining, by the server system, a set of donors who have donated for the second donation category based on a donation transaction history of the second donation category associated with the charity organization;
sending, by the server system, an authorization request signal to user devices of the set of donors for taking approval for disbursement from the second donation category for the first donation category; and
upon receiving successful authorization response from at least a threshold number of donors of the set of donors, facilitating, by the server system, spend for the first donation category from the second donation category.

20. The computer-implemented method of claim 19, further comprising:
receiving, by the server system, a receipt of spend transaction made by the charity organization for the particular donation category; and
upon receiving the receipt of spend transaction, determining, by the server system, a number of donors, whose donations are utilized in the spend transaction for the particular donation category, wherein the number of donors is associated to the number of donation transactions, and wherein the number of donations transactions are utilized in a chronological order of occurrence of donating event.
